(19) United States
(12) Patent Application Publication
(10) Pub. No.: US 2026/0021595 A1
(43) Pub. Date: Jan. 22, 2026

(54) JOINT, ROBOTIC ARM USING THE SAME AND ANALYTICAL METHOD USING THE SAME

(71) Applicant: INDUSTRIAL TECHNOLOGY RESEARCH INSTITUTE, Hsinchu (TW)

(72) Inventors: Hao-Yan WU, Taoyuan City (TW); Su-Jhen LIN, Kaohsiung City (TW); Yan-Ting CHEN, Linluo Township (TW); Hao OU YANG, New Taipei City (TW); Yu-Hsien LIU, Tainan City (TW); Huan-Sheng LI, Toufen City (TW); Chien-Yu WU, Kouhu Township (TW)

(73) Assignee: INDUSTRIAL TECHNOLOGY RESEARCH INSTITUTE, Hsinchu (TW)

(21) Appl. No.: 19/237,901

(22) Filed: Jun. 13, 2025

Related U.S. Application Data
(60) Provisional application No. 63/671,830, filed on Jul. 16, 2024.

(30) Foreign Application Priority Data
May 6, 2025 (TW) 114116963

(51) Int. Cl. B25J 17/02; B25J 19/00

(52) U.S. Cl. CPC B25J 17/0258; B25J 19/0095

(57) ABSTRACT

A joint includes a joint housing, a first fixing element and a second fixing element. The first fixing element is rotatably connected to the joint housing and has a first fixing portion. The second fixing element is fixed to the joint housing and has a second fixing portion. The first fixing portion and the second fixing portion respectively have matching structures.

This application claims the benefit of U.S. provisional application Ser. No. 63/671,830, filed Jul. 16, 2024 and the benefit of Taiwan application Serial No. 114116963, filed May 6, 2025, the disclosures of which are incorporated by reference herein in its entirety.

### TECHNICAL FIELD

The disclosure relates in general to a joint, a robotic arm using the same and an analytical method using the same.

### BACKGROUND

A robotic arm includes a plurality of joints that are connected to each other and may move relative to each other to perform a desired arm movement. However, current robotic arm is shipped as a complete unit, and the positions and connection methods of multiple joints of the robotic arm cannot be adjusted, and thus it limits the selection of specifications for robotic arms, and makes it difficult for manufacturers to flexibly respond to consumer demand.

### SUMMARY

According to an embodiment, a joint is provided. The joint includes a joint housing, a first fixing element, a second fixing element and a limiting element. The first fixing element is rotatably connected to the joint housing and includes a first fixing portion and a limiting protrusion. The second fixing element is fixed to the joint housing and has a second surface, a second abutting surface and a second fixing portion, wherein the second abutting surface extends inwardly relative to the second surface. The limiting element has a first surface, a first abutting surface and a limiting recess, wherein the first abutting surface extends outwardly relative to the first surface. The limiting protrusion is located in the limiting recess, and the first fixing portion and the second fixing portion respectively have structures that are matched.

According to another embodiment, a robotic arm is provided. The robotic arm includes a plurality of joints and a controller. Two of the joints are connected to each other, and each of the joints records joint information. The controller is electrically connected to the joints and configured to: obtain a configuration of a robotic arm of the joints according to the joint information sent back by each joint; and perform a robotics analysis on the configuration of the robotic arm. Each of the joints includes a joint housing, a first fixing element, a second fixing element and a limiting element. The first fixing element is rotatably connected to the joint housing and includes a first fixing portion and a limiting protrusion. The second fixing element is fixed to the joint housing and has a second surface, a second abutting surface and a second fixing portion, wherein the second abutting surface extends inwardly relative to the second surface. The limiting element has a first surface, a first abutting surface and a limiting recess, wherein the first abutting surface extends outwardly relative to the first surface. The limiting protrusion is located in the limiting recess, the first fixing portion and the second fixing portion respectively have structures that are matched, and the first fixing element of one of the joints is connected to the second fixing element of another of the joints.

According to an alternative embodiment, an analytical method for a robotic arm is provided. The analytical method includes the following steps: transmitting, by each of the joints, a joint information to a controller when a plurality of joints are electrically connected to a controller; obtaining, by the controller, a configuration of a robotic arm constituted by the joints according to the joint information sent back by each of the joints; and performing a robotics analysis on the configuration of the robotic arm.

### BRIEF DESCRIPTION OF THE DRAWINGS

FIG. 1 shows a schematic diagram of a joint according to an embodiment of the present disclosure;

FIG. 2 shows a schematic diagram of a joint according to another embodiment of the present disclosure;

FIG. 3 shows a schematic diagram of a joint according to another embodiment of the present disclosure;

FIG. 4 shows a schematic diagram of a joint according to another embodiment of the present disclosure;

FIG. 5 shows a schematic diagram of an elevation view of the joint in FIG. 4 viewed from -Z-axis;

FIG. 6 shows a schematic diagram of a cross-sectional view of the joint in FIG. 5 along a direction 6-6′;

FIG. 7 shows a schematic diagram of a cross-sectional view of a convex portion of the joint docking with a concave portion of the joint in FIG. 4;

FIG. 8 shows a schematic diagram of a cross-sectional view of the joint in FIG. 6 combined with the two joints;

FIG. 9A shows a schematic diagram of an exploded view of the robotic arm according to another embodiment of the present disclosure;

FIG. 9B shows a schematic diagram of an assembled view of the robotic arm in FIG. 9A;

FIG. 9C shows a schematic diagram of a robotic arm equivalent model of the robotic arm in FIG. 9B;

FIG. 10A shows a schematic diagram of an exploded view of the robotic arm according to another embodiment of the present disclosure;

FIG. 10B shows a schematic diagram of an assembled view of the robotic arm in FIG. 10A;

FIG. 10C shows a schematic diagram of a robotic arm equivalent model of the robotic arm in FIG. 10B;

FIG. 11A shows a schematic diagram of an exploded view of a robotic arm according to another embodiment of the present disclosure;

FIG. 11B shows a schematic diagram of an assembled view of the robotic arm in FIG. 11A;

FIG. 11C shows a schematic diagram of a robotic arm equivalent model of the robotic arm in FIG. 11B; and

FIG. 12 shows a flow chart of an analysis method for a robotic arm according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

In the drawings, the thickness of layers, films, panels, regions, etc., are exaggerated for clarity. Throughout the specification, the same reference numerals refer to the same elements. The terms “first”, “second”, etc. in this document do not limit the order, and they may only represent different component names. Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning consistent with their meaning in the context of the relevant art and the present disclosure, and will not be interpreted in an idealized or overly formal sense unless expressly so defined herein. Furthermore, the same elements or similar elements are denoted by the same reference numerals.

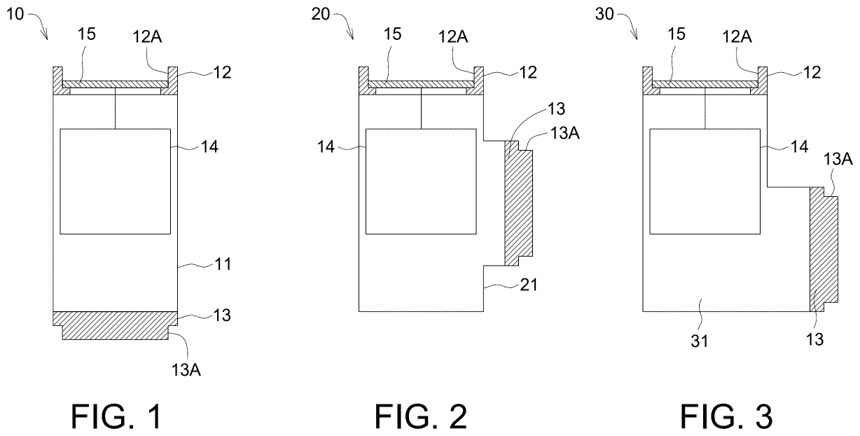

Referring to FIGS. 1 to 3, FIG. 1 shows a schematic diagram of a joint 10 according to an embodiment of the present disclosure, FIG. 2 shows a schematic diagram of a joint 20 according to another embodiment of the present disclosure, and FIG. 3 shows a schematic diagram of a joint 30 according to another embodiment of the present disclosure.

As illustrated in FIG. 1, the joint 10 includes a joint housing 11, a first fixing element 12, a second fixing element 13, a driver 14 and a limiting element (for example, a position-limiting element) 15. The first fixing element 12 is rotatably connected to the joint housing 11 and has a first fixing portion 12A.

The second fixing element 13 is fixed to the joint housing 11 and has a second fixing portion 13A. The first fixing portion 12A and the second fixing portion 13A respectively have structures that may be matched with each other. As a result, the first fixing portion 12A of one of the two joints 10 may be connected to the second fixing portion 13A of another of the two joints 10 to connect the two joints 10. In addition, due to the first fixing element 12 being rotatable relative to the joint housing 11, the first fixing portion 12A of the joint 10 may be rotatably connected to the second fixing portion 13A of another joint 10, so that the two joints may be quickly connected. Furthermore, due to the design of the joints of the embodiment of the present disclosure, a robotic arm may be quickly assembled, and the robotic arms with different configurations may be assembled.

In an embodiment, the first fixing portion 12A and the second fixing portion 13A are threads. For example, the first fixing portion 12A is a female thread, and the second fixing portion 13A is a male thread. As a result, the two joints 10 may be connected through screwing.

As illustrated in FIG. 1, the joint housing 11 extends, for example, along a straight line, and the first fixing element 12 and the second fixing element 13 are respectively disposed at two opposite ends of the joint housing 11. The limiting element 15 is connected to the driver 14 for being driven by the driver 14. In an embodiment, the limiting element 15 may be fixed to a rotating shaft (not shown) of the driver 14. The driver 14 is, for example, a motor. When the first fixing element 12 of the joint 10 is connected to the second fixing element 13 of another joint 10, the relative position among the limiting element 15, the first fixing element 12 of the joint 10 and the second fixing element 13 of another joint 10 are fixed. As a result, when the driver 14 operates, the joint 10 and another joint 10 may move relative to each other.

As illustrated in FIG. 2, the joint 20 includes a joint housing 21, a first fixing element 12, a second fixing element 13, a driver 14 and a limiting element 15. The first fixing element 12 is rotatably connected to the joint housing 21 and has a first fixing portion 12A. The second fixing element 13 is fixed to the joint housing 21 and has a second fixing portion 13A. The first fixing portion 12A and the second fixing portion 13A respectively have structures that may be matched with each other. As a result, the first fixing portion 12A of one of the two joints 20 may be connected to the second fixing portion 13A of another of the two joints 20 to connect the two joints 20. In addition, due to the first fixing element 12 being rotatable relative to the joint housing 21, the first fixing portion 12A of the joint 20 may be rotatably connected to the second fixing portion 13A of another joint 20.

As illustrated in FIG. 2, different from the joint housing 11 of the previous embodiment, the joint housing 21 of the present embodiment is, for example, T-shaped, and the first fixing element 12 and the second fixing element 13 are respectively disposed on two adjacent sides of the joint housing 11.

As illustrated in FIG. 3, the joint 30 includes a joint housing 31, a first fixing element 12, a second fixing element 13, a driver 14 and a limiting element 15. The first fixing element 12 is rotatably connected to the joint housing 31 and has a first fixing portion 12A. The second fixing element 13 is fixed to the joint housing 31 and has a second fixing portion 13A. The first fixing portion 12A and the second fixing portion 13A respectively have structures that may be matched with each other. As a result, the first fixing portion 12A of one of the two joints 30 may be connected to the second fixing portion 13A of another of the two joints 30 to connect the two joints 30. In addition, due to the first fixing element 12 being rotatable relative to the joint housing 31, the first fixing portion 12A of the joint 30 may be rotatably connected to the second fixing portion 13A of another joint 30.

As illustrated in FIG. 3, different from the joint housing 11 of the previous embodiment, the joint housing 31 of the present embodiment is extended in an L-shape, for example, and the first fixing element 12 and the second fixing element 13 are respectively disposed at two ends of the joint housing 31.

In an embodiment, two of the joint 10 of FIG. 1, the joint 20 of FIG. 2, and the joint 30 of FIG. 3 may be connected to form a robotic arm, wherein the robotic arm may include at least two joints.

In summary, the joint housing of the joint may extend along at least one straight line, at least one curved-line or a combination thereof, and the first fixing element and the second fixing element of the joint may be disposed at two ends or two adjacent sides of the joint housing. The two joints may be quickly assembled and disassembled by rotating the first fixing element of the joint.

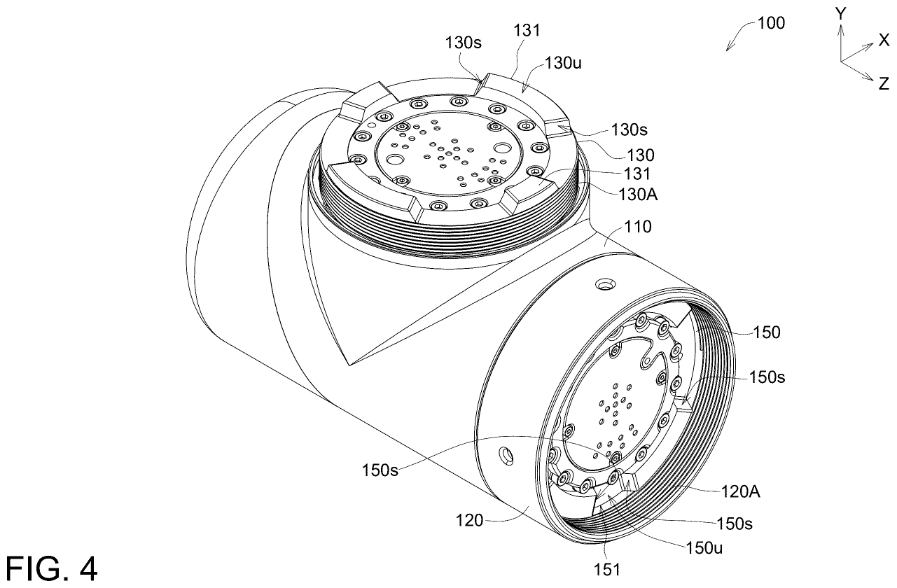

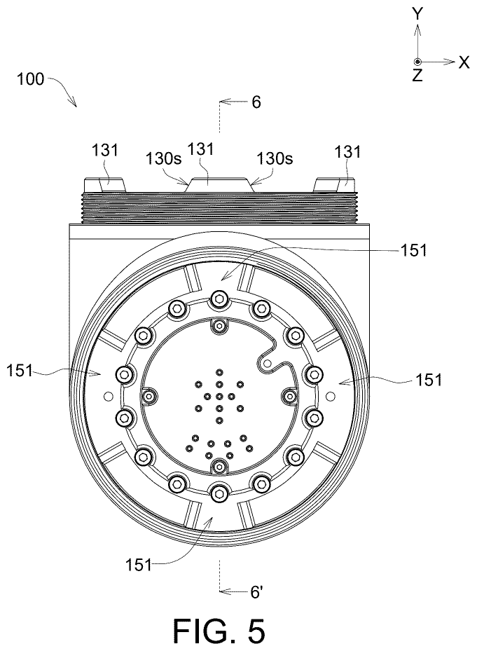

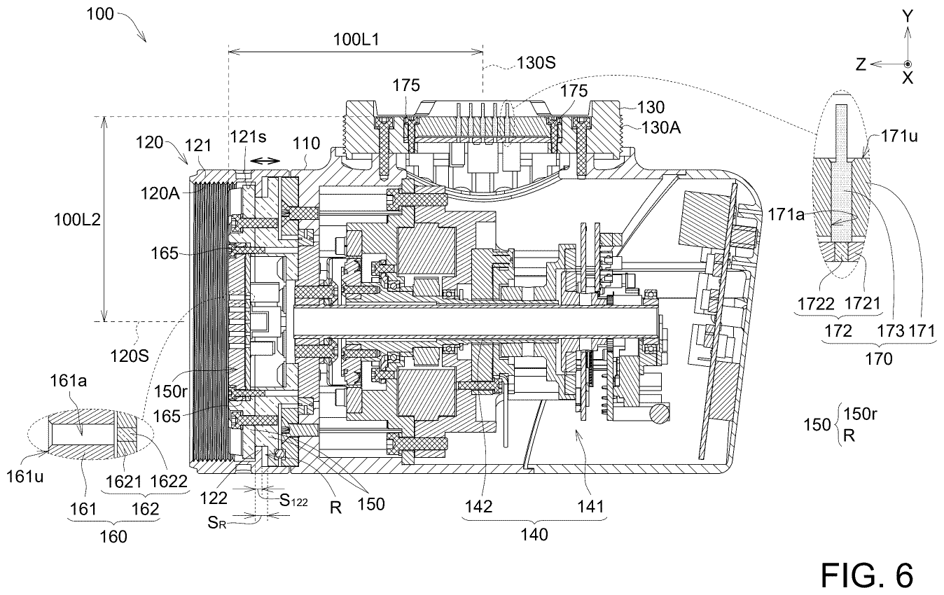

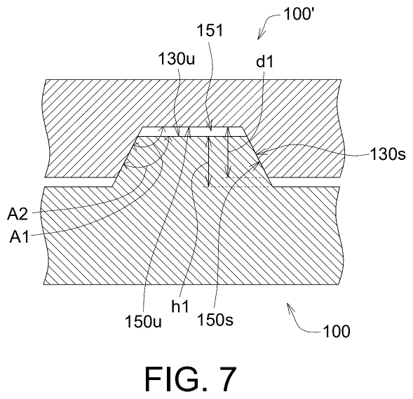

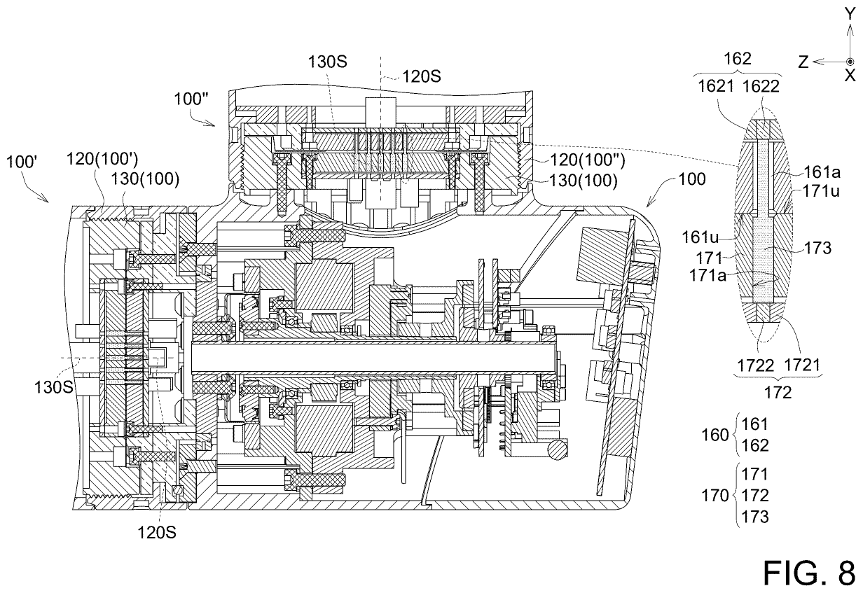

Referring to FIGS. 4 to 8, FIG. 4 shows a schematic diagram of a joint 100 according to another embodiment of the present disclosure, FIG. 5 shows a schematic diagram of an elevation view of the joint 100 in FIG. 4 viewed from -Z-axis, FIG. 6 shows a schematic diagram of a cross-sectional view of the joint 100 in FIG. 5 along a direction 6-6′, FIG. 7 shows a schematic diagram of a cross-sectional view of a convex portion 131 of the joint 100 docking with a concave portion 151 of the joint 100′ in FIG. 4, and FIG. 8 shows a schematic diagram of a cross-sectional view of the joint 100 in FIG. 6 combined with the two joints 100′ and 100″.

As illustrated in FIG. 4, the joint 100 includes a joint housing 110, a first fixing element 120, a second fixing element 130, a driver 140 and a limiting element (for example, a position-limiting element) 150. The first fixing element 120 is rotatably connected to the joint housing 110 and has a first fixing portion 120A. The second fixing element 130 is fixed to the joint housing 110 and has a second fixing portion 130A. The first fixing portion 120A and the second fixing portion 130A respectively have structures that may be matched with each other. As a result, the first fixing portion 120A of one of the two joints 100 may be connected to the second fixing portion 130A of another of the two joints 100 to connect the two joints 100. In addition, due to the first fixing element 120 being rotatable relative to the joint housing 110, the first fixing portion 120A of the joint 100 may be rotatably connected to the second fixing portion 130A of another joint 100.

As illustrated in FIG. 8, the joint 100 and the joint 100′ may have the same or similar structure and/or the joint 100 and the joint 100″ may have the same or similar structure, and they will not be repeated here. The joint 100′ and the joint 100″ may have the same or similar structure, and it will not be repeated here. The first fixing element 120 of the joint 100 is connected to the second fixing element 130 of the joint 100′. As a result, through the rotation of the first fixing element 120 of the joint 100, the first fixing element 120 of the joint 100 and the second fixing element 130 of the joint 100′ may be quickly connected or separated. In addition, the second fixing element 130 of the joint 100 is connected to the first fixing element 120 of the joint 100″. As a result, through the rotation of the first fixing element 120 of the joint 100″, the first fixing element 120 of the joint 100″ and the second fixing element 130 of the joint 100 may be quickly connected or separated.

In an embodiment, the first fixing portion 120A and the second fixing portion 130A are threads. For example, the first fixing portion 120A is a female thread, and the second fixing portion 130A is a male thread. As a result, two joints may be connected by screwing. In the present embodiment, the first fixing element 120 is, for example, an annular element, and the first fixing portion 120A is a female thread of the annular element. In an embodiment, the thread has 8 threads and/or the pitch is 1.5 mm, for example, which may provide sufficient strength to withstand a load generated by the movement after the two joints are connected.

As illustrated in FIGS. 6 and 8, the limiting element 150 is connected to the driver 140. When the first fixing element 120 of the joint 100 is connected to the second fixing element 130 of the joint 100′, the relative positions among the limiting element 150 of the joint 100, the first fixing element 120 of the joint 100 and the second fixing element 130 of the joint 100′ are fixed (for example, a freedom of movement of the joint 100 and the joint 100′ along a docking direction is constrained, and a freedom of rotation around the docking direction is constrained). As a result, when the driver 140 operates, the joint 100 and the joint 100′ may move relative to each other. For example, the joint housing 110 of the joint 100 moves relative to the joint housing 110 of the joint 100′, or the joint housing 110 of the joint 100′ moves relative to the joint housing 110 of the joint 100. In an embodiment, the driver 140 is, for example, a motor.

As illustrated in FIG. 6, the driver 140 is disposed within the joint housing 110 and includes at least one driving module 141 and a rotating shaft 142. The driving module 141 is connected to the rotating shaft 142 and drives the rotating shaft 142 to rotate (e.g., rotate around Z-axis). The driving module 141 includes elements such as an electromagnet, a coil, etc., and may convert electrical energy into mechanical energy. The rotating shaft 142 may be directly or indirectly connected to (e.g., fixed to) the limiting element 150.

As illustrated in FIG. 6, the limiting element 150 is rotatable relative to the joint housing 110. For example, the limiting element 150 may be directly or indirectly fixed to the rotating shaft 142 of the driver 140 for rotating synchronously with the rotating shaft 142. The limiting element 150 has a limiting recess (for example, a position-limiting recess) R, and a moving stroke of the first fixing element 120 is determined by the limiting recess R. For example, the first fixing element 120 includes a fixing element body 121 and at least one limiting protrusion (for example, a position-limiting protrusion) 122, the limiting protrusion 122 is connected to an inner peripheral surface 121s of the fixing element body 121 and protrudes relative to the inner peripheral surface 121s, and the aforementioned first fixing portion 120A is formed on the inner peripheral surface 121s of the fixing element body 121. In the present embodiment, the limiting protrusion 122 is located in the limiting recess R and is constrained by the limiting recess R.

As illustrated in FIG. 6, when the first fixing element 120 of the joint 100 is in a free state (not connected to the joint 100′), the first fixing element 120 of the joint 100 is rotatable relative to the joint housing 110, and due to the limiting protrusion 122 being constrained in the limiting recess R, the first fixing element 120 will not separate from the joint housing 110 along Z-axis. In an embodiment, a dimension S_{R} of the limiting recess R along a direction (e.g., Z-axis) is greater than a dimension S₁₂₂ of the limiting protrusion 122 along the same direction. Thus, the moving stroke of the first fixing element 120 along Z-axis is ΔS, where ΔS=S_{R}−S₁₂₂. As illustrated in FIG. 8, the first fixing element 120 of the joint 100 and the second fixing element 130 of the joint 100′ may be screwed together until the limiting protrusion 122 of the first fixing element 120 of the joint 100 presses the limiting element 150 of the joint 100 against the second fixing element 130 of the joint 100′, so as to fix the relative positions among the limiting element 150 of the joint 100, the first fixing element 120 of the joint 100 and the second fixing element 130 of the joint 100′. As a result, when the driver 140 operates, the joint 100 and the joint 100′ may move relative to each other, for example, the joint housing 110 of the joint 100 moves relative to the joint housing 110 of the joint 100′, or the joint housing 110 of the joint 100′ moves relative to the joint housing 110 of the joint 100.

As illustrated in FIGS. 4, 6 and 7, the limiting element 150 has a first surface 150u and at least one first abutting surface 150s. The first abutting surface 150s extends outward relative to the first surface 150u. Furthermore, the limiting element 150 includes at least one concave portion 151, the first surface 150u is, for example, a bottom surface of the concave portion 151, and the first abutting surface 150s is, for example, a lateral wall of the concave portion 151. The second fixing element 130 has a second surface 130u and at least one second abutting surface 130s. The second abutting surface 130s extends inward relative to the second surface 130u. Furthermore, the second fixing element 130 includes at least one convex portion 131, the second surface 130u is, for example, a top surface of the convex portion 131, and the second abutting surface 130s is, for example, a lateral wall of the convex portion 131. A slope of the first abutting surface 150s is the same as a slope of the second abutting surface 150s. As a result, when the joint 100 is connected to the joint 100′, a contact area between the first abutting surface 150s and the second abutting surface 130s is the greatest or greater (if the slope is different, the contact area will be reduced), thereby reducing the contact stress and increasing the connection stability.

As illustrated in FIGS. 6 and 7, the limiting element 150 includes at least one concave portion 151, the first surface 150u is a bottom surface of the concave portion 151, and the first abutting surface 150s is a lateral wall of the concave portion 151. The first abutting surface 150s is inclined relative to the first surface 150u and there is an angle A1 between the first abutting surface 150s and the first surface 150u. The second fixing element 130 includes at least one convex portion 131. The second surface 130u is a top surface of the convex portion 131, and the second abutting surface 130s is the lateral wall of the convex portion 131. The second abutting surface 130s is inclined relative to the second surface 130u and there is an angle A2 between the second abutting surface 130s and the second surface 130u. In the present embodiment, the angle A1 is substantially equal to the angle A2. As a result, when the joint 100 is connected to the joint 100′, the contact area between the first abutting surface 150s and the second abutting surface 150s is the greatest or greater (if the slope is different, the contact area will be reduced), thereby reducing the contact stress and increasing the connection stability. In an embodiment, the angle A1 and/or the angle A2 is, for example, greater than 90 degrees and less than 150 degrees, such as 135 degrees. Due the angle A1 and/or the angle A2 being greater than 90 degrees, the connection between the concave portion 151 of the limiting element 150 and the convex portion 131 of the second fixing element 130 may also be referred to as “tapering”. Through the aforementioned slope design, the convex portion 131 of the joint 100 and the concave portion 151 of the joint 100′ may be quickly aligned.

As illustrated in FIG. 7, when the concave portion 151 of the limiting element 150 is docked (or connected) with the convex portion 131 of the second fixing element 130, the first surface 150u of the concave portion 151 and the second surface 130u of the convex portion 131 may not be in contact with each other. Furthermore, through the tapered design of the concave portion 151 and the convex portion 131, the first surface 150u of the concave portion 151 and the second surface 130u of the convex portion 131 do not need to abut against each other. Since the first surface 150u of the concave portion 151 and the second surface 130u of the convex portion 131 do not need to abut against each other, the condition of “the depth d1 of the concave portion 151 is equal to the height h1 of the convex portion 151” is not a necessary design condition, and it may reduce design complexity and manufacturing cost.

As illustrated in FIG. 5, the limiting element 150 has a plurality of concave portions 151. In the present embodiment, two concave portions 151 are disposed along X-axis, and another two concave portions 151 are disposed along Y-axis. As a result, when the convex portion 131 of the second fixing element 130 is connected to the concave portion 151 of the limiting element 150, the freedom of movement of joint 100 and joint 100′ along X-axis, the freedom of movement along Y-axis, the freedom of rotation around X-axis, and the freedom of rotation around Y-axis may be constrained.

As illustrated in FIG. 6, the joint 100 further includes a first circuit module 160 and a second circuit module 170. The limiting element 150 has a receiving portion 150r, and the first circuit module 160 may be disposed in the receiving portion 150r. The first circuit module 160 and the limiting element 150 may be fixed to each other. For example, the first circuit module 160 and the limiting element 150 are fixed to each other via at least one bolt 165. The first circuit module 160 includes a first carrier 161 and a first circuit board 162. The first carrier board 161 has at least one first through hole 161a. The first circuit board 162 includes a first board body 1621 and at least one first electrical pad 1622. The first electrical pad 1622 is disposed on the first board body 1621. The first through hole 161a and the first electrical pad 1622 correspond in position, and the first electrical pad 1622 is exposed from the first through hole 161a.

As illustrated in FIG. 6, the second circuit module 170 and the second fixing element 130 are fixed to each other via at least one bolt 175. The second circuit module 170 includes a second carrier board 171, a second circuit board 172 and an electrical connection element 173. The second carrier board 171 has at least one second through hole 171a. The second circuit board 172 includes a second board body 1721 and at least one second electrical pad 1722, wherein the second electrical pad 1722 is disposed on the second board body 1721. The second through hole 171a and the second electrical pad 1722 correspond in position, and the second electrical pad 1722 is exposed from the second through hole 171a. The electrical connection element 173 is electrically connected to the corresponding second electrical pad 1722 through the corresponding second through hole 171a. In an embodiment, the electrical connection element 173 is, for example, an elastic pin which has elasticity. When the electrical connection element 173 of the joint 100 is pressed against the first electrical pad 1622 of the joint 100′, the electrical connection element 173 is electrically connected to the first electrical pad 1622, and the electrical connection element 173 provides the first electrical pad 1622 with a pre-pressure to ensure the stability of the electrical connection between the electrical connection element 173 and the first electrical pad 1622.

In another embodiment, the electrical connection element 173 may be disposed in the first through hole 161a of the first carrier 161 and electrically connected to the corresponding first electrical pad 1622. When the electrical connection element 173 of the joint 100 is pressed against the second electrical pad 1722 of the joint 100′ through the second through hole 171a of the second carrier plate 171, the electrical connection element 173 is electrically connected to the second electrical pad 1722, and the electrical connection element 173 may provide the second electrical pad 1722 with a pre-pressure to ensure the stability of the electrical connection between the electrical connection element 173 and the second electrical pad 1722.

As illustrated in FIG. 8, when the first circuit module 160 is docked to the second circuit module 170, the first electrical pad 1622 of the first circuit module 160 is connected to the electrical connection element 173 of the second circuit module 170, so that the first circuit board 162 is electrically connected to the second circuit board 172.

As illustrated in FIGS. 6 and 8, the first carrier 161 has an end surface 161u, and the second carrier 171 has an end surface 171u. There is a dimension 100L1 between a central axis 130S of the second fixing element 130 and an end surface 161u of the first carrier 161 (dimension 100L1 is illustrated in FIG. 6), and there is a dimension 100L2 between a central axis 120S of the first fixing element 120 and the end surface 171u of the second carrier 171 (dimension 100L2 is illustrated in FIG. 6). The dimensions 100L1 and 100L2 may be recorded in a memory (not illustrated), wherein the memory may be disposed and electrically connected to the first circuit board 162 of the first circuit module 160 or the second circuit board 172 of the second circuit module 170. Although not illustrated, the first circuit module 160 further includes at least one first chip which may be disposed on and electrically connected to the first circuit board 162 of the first circuit module 160, and/or the second circuit module 170 further includes at least one second chip which may be disposed on and electrically connected to the second circuit board 172 of the second circuit module 170. The first chip and/or the second chip may control the operation of the driver 140 and/or communicate with the joint and/or controller electrically connected thereto.

In summary, the first fixing element 120, the limiting element 150 and the first circuit module 160 of the joint 100 are located at a first connection end of the joint, and the second fixing element 130 and the second circuit module 170 are located at a second connection end of the joint, wherein the first connection end is, for example, a female end (or female connector), while the second connection end is, for example, a male end (or male connector).

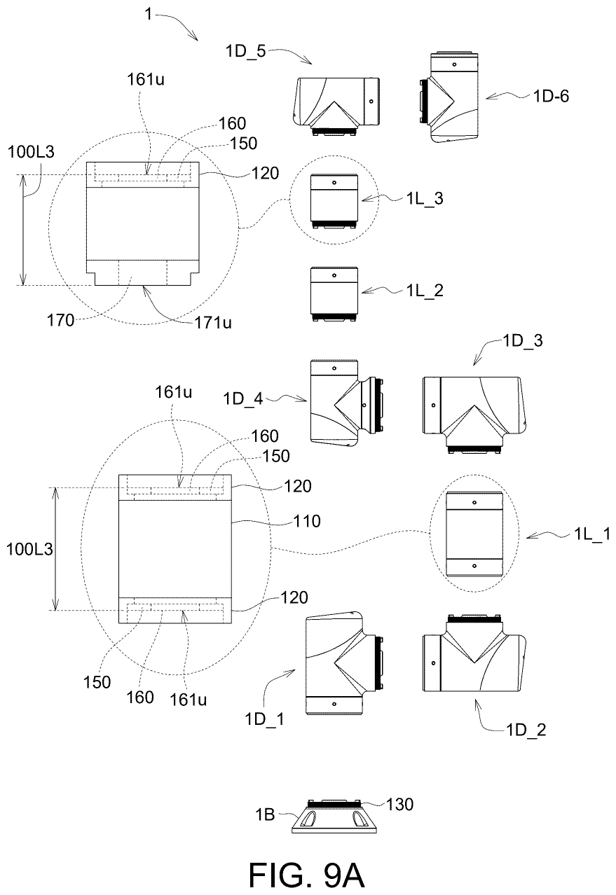

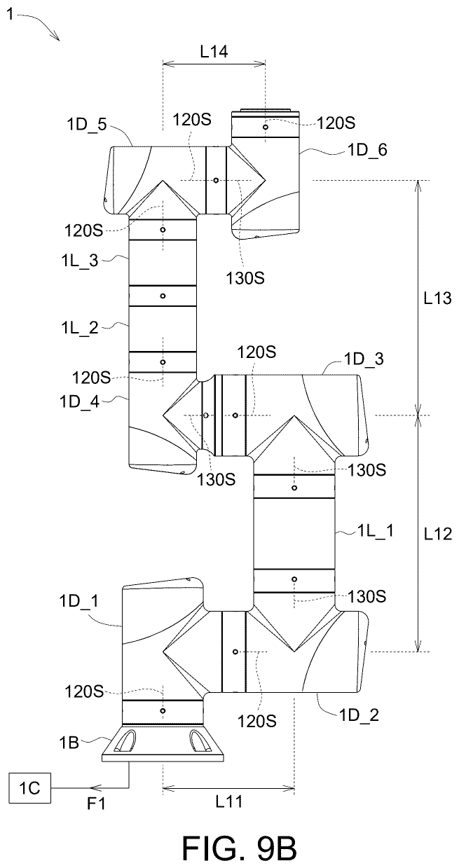

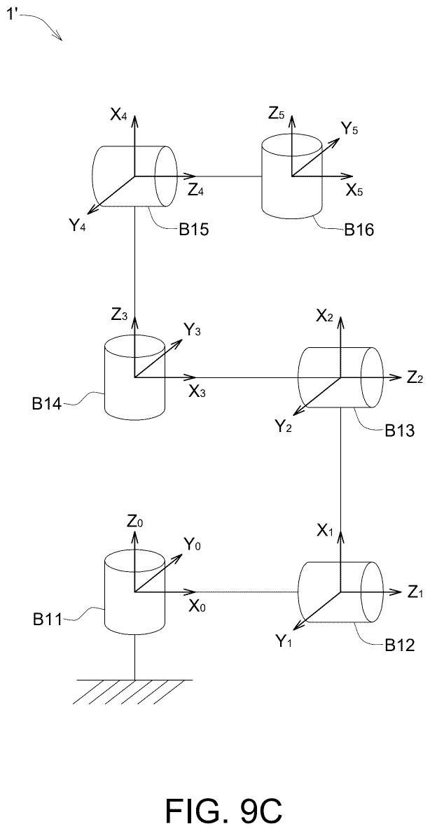

Referring to FIGS. 9A to 9C, FIG. 9A shows a schematic diagram of an exploded view of the robotic arm 1 according to another embodiment of the present disclosure, FIG. 9B shows a schematic diagram of an assembled view of the robotic arm 1 in FIG. 9A, and FIG. 9C shows a schematic diagram of a robotic arm equivalent model 1′ of the robotic arm 1 in FIG. 9B.

As illustrated in FIGS. 9A and 9B, the robotic arm 1 includes a base 1B, a driving joint 1D_1, a driving joint 1D_2, a driving joint 1D_3, a driving joint 1D_4, a driving joint 1D_5, a connecting-rod joint 1L_1, a connecting-rod joint 1L_2, a connecting-rod joint 1L_3, a driving joint 1D_6 and a controller 1C. The base 1B at least includes the aforementioned second fixing element 130 and the second circuit module 170, the driving joints 1D_1, 1D_2, 1D_3, 1D_4, 1D_5 and 1D_6 each includes the structure of the aforementioned joint 100 or are itself is the joint 100, and the connecting-rod joints 1L_1, 1L_2 and 1L_3 each includes the same or similar structure as the aforementioned joint 100, but the difference is that the connecting-rod joint may omit the driver, and the limit element is fixed to the joint housing of the connecting-rod joint. In other words, compared to the driving joint, the connecting-rod joint omits the driver.

Taking the connecting-rod joint 1L_1 as an example, as illustrated in FIG. 9A, the connecting-rod joint 1L_1 includes the joint housing 110, two first fixing elements 120, two limiting elements 150 and two second circuit modules 170, wherein the joint housing 110 is a straight cylinder, one of the two first fixing elements 120, one of the two limiting elements 150 and one of the two second circuit modules 170 are located at an end of the joint housing 110, and the other of the two first fixing elements 120, the other of the two limiting elements 150 and the other of the two second circuit modules 170 are located at another end of the joint housing 110. A distance between the two end surfaces 171u of the two second circuit modules 170 is a dimension 100L3. The dimension 100L3 may be recorded in a memory (not illustrated), wherein the memory may be disposed on and electrically connected to the second circuit board 172 of the second circuit module 170.

Taking the connecting-rod joint 1L_2 as an example, as illustrated in FIG. 9A, the connecting-rod joint 1L_1 includes the joint housing 110, the first fixing element 120, the second fixing element 130, the limiting element 150, the first circuit module 160 and the second circuit module 170, wherein the first fixing element 120, the limiting element 150 and the first circuit module 160 are disposed at one end of the joint housing 110, and the second fixing element 130 and the second circuit module 170 are disposed at another end of the joint housing 110. The distance between the end surface 161u of the first circuit module 160 and the end surface 171u of the second circuit module 170 is a dimension 100L3. The dimension 100L3 may be recorded in a memory (not shown), wherein the memory may be disposed on and electrically connected to a first circuit board (not illustrated) of the first circuit module 160 or a second circuit board (not illustrated) of the second circuit module 170. In addition, the connecting-rod joint 1L_3 has the same or similar structure as the connecting- rod joint 1L_2, and it will not be repeated herein.

As illustrated in FIG. 9B, two of the joints in FIG. 9A may be connected together using the manner as described above. For example, the driving joint 1D_1 is connected to the base 1B, the driving joint 1D_2 is connected to the driving joint 1D_1, the connecting-rod joint 1L_1 is connected to the driving joint 1D_2, the driving joint 1D_3 is connected to the connecting-rod joint 1L_1, the driving joint 1D_4 is connected to the driving joint 1D_3, the connecting-rod joint 1L_2 is connected to the driving joint 1D_4, the connecting-rod joint 1L_3 is connected to the connecting-rod joint 1L_2, the driving joint 1D_5 is connected to the connecting-rod joint 1L_3, and the driving joint 1D_6 is connected to the driving joint 1D_5.

As illustrated in FIG. 9B, the controller 1C is electrically connected to the robotic arm 1. Each joint may communicate with the controller 1C via the EtherCAT communication protocol. Each joint records joint information F1. When the joint is electrically connected to the controller 1C, the joint may transmit joint information F1 to the controller 1C. The controller 1C is configured to obtain a configuration of the robotic arm 1, as illustrated in FIG. 9B, according to the joint information F1 sent back by each joint; and perform a robotics analysis on the configuration of the robotic arm 1, such as kinematic analysis and/or kinematical analysis.

The joint information F1 includes a joint identification code, a joint dimension (or size) and/or a driver specification, wherein the joint identification code is, for example, identification information of the joint. Different joints have different joint identification codes, and the driver specification includes a driver weight, a driver torque and/or a driver speed. Taking the joint 100 illustrated in FIG. 6 as an example, the joint dimensions of the joint information F1 of the joint 100 include the dimensions 100L1 and 100L2; similarly, the joint dimensions of the joint information F1 of each of the driving joints 1D_1 to 1D_6 in FIG. 9A include the dimensions 100L1 and 100L2 (the dimensions 100L1 and 100L2 are not illustrated in FIG. 9A). For example, the connecting-rod joint 1L_1, the joint dimension of its joint information F1 includes the aforementioned dimension 100L3. The driver weight, the driver torque and the driver rotation speed are the weight of the driver 140, the working torque of the driver 140 and the working rotation speed of the driver 140 respectively.

As illustrated in FIGS. 9B and 9B, when the robotic arm 1 is assembled, the controller 1C may obtain an assembly sequence and/or an assembly posture of these joints (for example, the pairing of two fixing elements of two joints) according to the joint identification code of the joint information F1 of each joint to obtain the configuration of the robotic arm 1. For another example, the controller 1C may obtain the characteristic dimensions L11, L12, L13 and L14 of the robotic arm 1 according to the joint dimensions (100L1, 100L2 and/or 100L3) of the joint information F1 of each joint. The characteristic dimension L11 is, for example, the distance between the central axis 120S of the driving joint 1D_1 and the central axis 130S of the driving joint 1D_2, the characteristic dimension L12 is, for example, the distance between the central axis 120S of the driving joint 1D_2 and the central axis 120S of the driving joint 1D_3, the characteristic dimension L13 is, for example, the distance between the central axis 120S of the driving joint 1D_3 and the central axis 130S of the driving joint 1D_6, and the characteristic dimension L14 is, for example, the distance between the central axis 120S of the driving joint 1D_6 and the central axis 120S of the driving joint 1D_5. The controller 1C may perform kinematic analysis on the robotic arm 1, by using appropriate kinematic analysis technology, according to these characteristic dimensions L11, L12, L13 and L14 to obtain a position analysis result, a velocity analysis result and/or an acceleration analysis result of the robotic arm 1.

In an embodiment, the controller 1C may perform kinematic analysis on the robotic arm 1, by using appropriate dynamic analysis technology, according to these characteristic dimensions L11, L12, L13 and L14 and the driver weight, the driver torque and/or the driver speed of the joint information F1 of each joint to obtain a power output analysis result, a torque output analysis result and/or a force output analysis results of the robotic arm 1.

As illustrated in FIG. 9B, the number of degrees of freedom (DoF) of the robotic arm 1 is determined by the number of driving joints. For example, if the number of the driving joints 1D_1, 1D_2, 1D_3, 1D_4, 1D_5 and 1D_6 is six, the robotic arm 1 is a six-axis robotic arm. The robotic arm 1 in FIG. 9B is upright-type when in use, so the robotic arm 1 may be defined as a six-axis vertical robotic arm. As illustrated in FIG. 9C, the robotic arm equivalent model 1′ includes a plurality of blocks B11 to B16 which respectively represent the driving joints 1D_1, 1D_2, 1D_3, 1D_4, 1D_5 and 1D_6. Z₀ represents the rotational freedom of the driving joint 1D_1 relative to the base 1B, Z₁ represents the rotational freedom of the driving joint 1D_2 relative to the driving joint 1D_1, Z₂ represents the rotational freedom of the driving joint 1D_4 relative to the driving joint 1D_3, Z₃ represents the rotational freedom of the connecting-rod joint 1L_2 relative to the driving joint 1D_4, Z₄ represents the rotational freedom of the driving joint 1D_6 relative to the driving joint 1D_5, and Z₅ represents the rotational freedom of another docking element (not illustrated, such as a flange or another joint) relative to the driving joint 1D_6, wherein the another docking element is connected to the driving joint 1D_6.

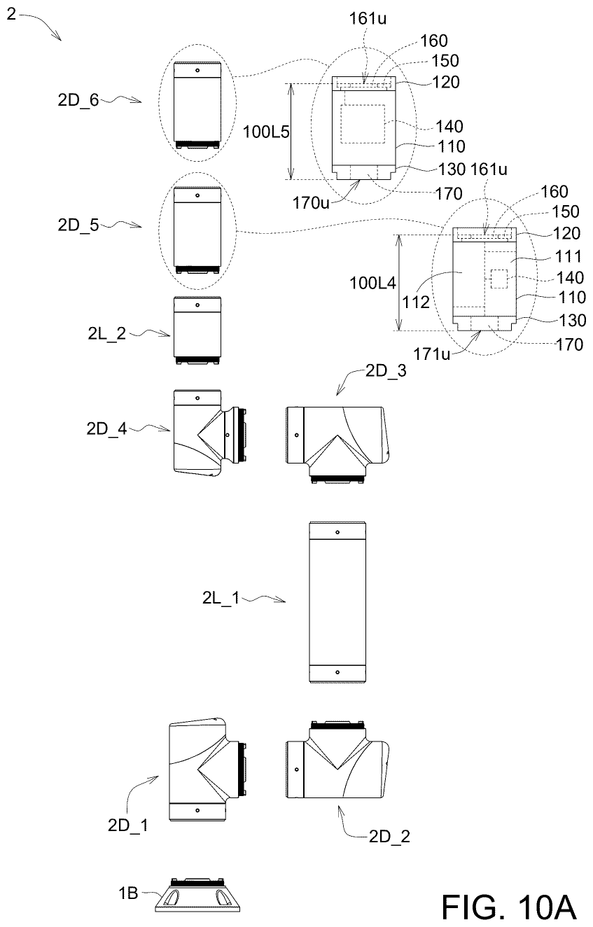

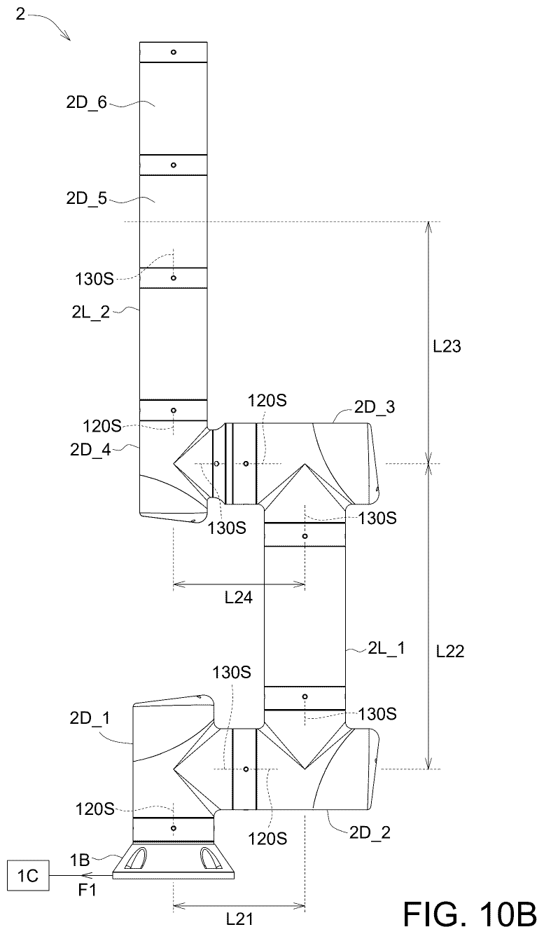

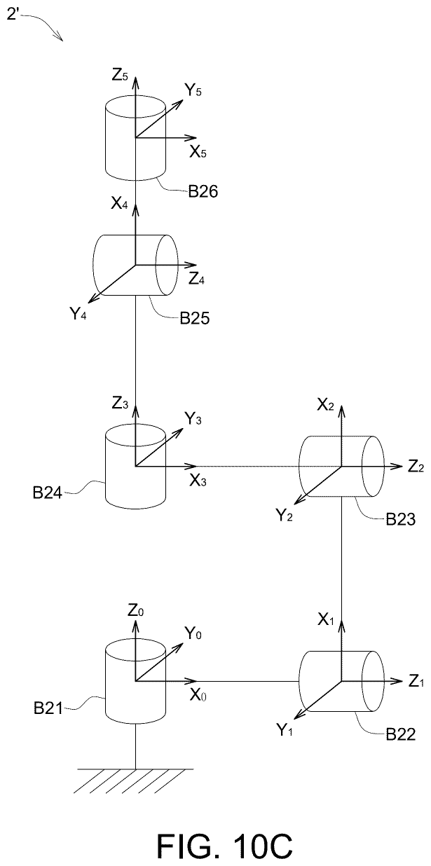

Referring to FIGS. 10A and 10B, FIG. 10A shows a schematic diagram of an exploded view of the robotic arm 2 according to another embodiment of the present disclosure, FIG. 10B shows a schematic diagram of an assembled view of the robotic arm 2 in FIG. 10A, and FIG. 10C shows a schematic diagram of a robotic arm equivalent model 2′ of the robotic arm 2 in

FIG. 10B.

As illustrated in FIG. 10A, the robotic arm 2 includes the base 1B, a driving joint 2D_1, a driving joint 2D_2, a connecting-rod joint 2L_1, a driving joint 2D_3, a driving joint 2D_4, a connecting-rod joint 2L_2, a driving joint 2D_5, a driving joint 2D_6 and a controller 1C. Each of the driving joint 2D_1, the driving joint 2D_2, the driving joint 2D_3 and the driving joint 2D_4 includes the structure of the joint 100 or itself is the joint 100.

As illustrated in FIG. 10A, the driving joint 2D_5 includes the structure of the aforementioned joint 100, and the difference is that the structure of the joint housing of the driving joint 2D_5 is different. For example, the joint housing of the driving joint 2D_5 includes a first housing 111 and a second housing 112, wherein the first housing 111 and the second housing 112 are pivotally connected, for example, the first housing 111 and the second housing 112 may rotate relative to each other around Z₄-axis (Z₄-axis is illustrated in FIG. 10C). The first fixing element 120, the limiting element 150 and the first circuit module 160 of the driving joint 2D_5 are disposed at an end of the second housing 112, while the second fixing element 130 and the second circuit module 170 are disposed at an end of the first housing 111. In the present embodiment, the driver 140 may be located in the first housing 111 and connected to the second housing 112 for driving the second housing 112 to rotate around Z₄-axis. The relative relationship among the first housing 111, the second fixing element 130 and the second circuit module 170 is fixed (for example, through at least one screw), the relative relationship among the second housing 112, the limiting element 150 and the first circuit module 160 is fixed (for example, through at least one screw), and the first fixing element 120 may rotate relative to the second housing 112. Thus, when the driver 140 drives the first housing 111 to rotate around Z₄-axis, the first housing 111 and the second housing 112 may rotate relative to each other around Z₄-axis. For example, the first housing 111 rotates relative to the second housing 112 around Z₄-axis, or the second housing 112 rotates relative to the first housing 111 around Z₄-axis.

As illustrated in FIG. 10A, the distance between the end face 161u of the first circuit module 160 of the driving joint 2D_5 and the end face 171u of the second circuit module 170 is the dimension 100L4. The dimension 100L4 may be recorded in a memory (not illustrated), wherein the memory may be disposed on and electrically connected to the first circuit board (not illustrated) of the first circuit module 160 or the second circuit board (not illustrated) of the second circuit module 170. The connecting-rod joints 2L_1 and 2L_2 each includes a structure the same as or similar to that of the connecting-rod joint 1L_1, and they will not be repeated herein.

As illustrated in FIG. 10A, the driving joint 2D_6 includes the structure of the aforementioned joint 100, and the difference is that the joint body 110 of the joint 100 is a straight cylinder, and the first fixing element 120, the limiting element 150 and the first circuit module 160 are disposed on an end of the joint body 110, and the second fixing element 130 and the second circuit module 170 are disposed on the other end of the joint body 110. The driver 140 is connected to the limiting element 150 to drive the limiting element 150 to rotate.

As illustrated in FIG. 10A, the distance between the end face 161u of the first circuit module 160 of the driving joint 2D_6 and the end face 171u of the second circuit module 170 is the dimension 100L5, and the dimension 100L5 may be recorded in a memory (not illustrated), where the memory may be disposed on and electrically connected to the first circuit board (not illustrated) of the first circuit module 160 or the second circuit board (not illustrated) of the second circuit module 170.

As illustrated in FIG. 10B, two of the joints in FIG. 10A may be connected together using the manner as described above. For example, the driving joint 2D_1 is connected to the base 1B, the driving joint 2D_2 is connected to the driving joint 2D_1, the connecting-rod joint 2L_1 is connected to the driving joint 2D_2, the driving joint 2D_3 is connected to the connecting-rod joint 2L_1, the driving joint 2D_4 is connected to the driving joint 2D_3, the connecting-rod joint 2L_2 is connected to the driving joint 2D_4, the driving joint 2D_5 is connected to the connecting-rod joint 2L_2, and the driving joint 2D_6 is connected to the driving joint 2D_5.

As illustrated in FIG. 10B, the controller 1C is electrically connected to the robotic arm 2. Each joint may communicate with the controller 1C via the EtherCAT communication protocol. Each joint records the joint information F1. When the joint is electrically connected to the controller 1C, the joint may transmit joint information F1 to the controller 1C. The controller 1C is configured to obtain the configuration of the robotic arm 2 according to the joint information F1 sent back by each joint, as illustrated in FIG. 10B; and perform the robotics analysis on the configuration of the robotic arm 2, such as kinematic analysis and/or kinematical analysis. The kinematic analysis and/or kinematic analysis performed by the controller 1C on the robotic arm 2 is similar to the kinematic analysis and/or kinematic analysis performed on the robotic arm 1, and they will not be repeated herein.

The joint information F1 includes the joint identification code, the joint dimension (or size) and/or the driver specification, wherein the joint identification code is, for example, the identification information of the joint. Different joints have different joint identification codes, and the driver specification includes the driver weight, the driver torque and/or the driver speed. Taking the joint 100 illustrated in FIG. 6 as an example, the joint dimensions of the joint information F1 of the joint 100 include the dimensions 100L1 and 100L2; similarly, the joint dimensions of the joint information F1 of each of the driving joints 2D_1 to 2D_5 in FIG. 10A include the dimensions 100L1 and 100L2 (the dimensions 100L1 and 100L2 are not illustrated in FIG. 10A). For the connecting-rod joints 2L_1 and 2L_2, the joint dimension of the joint information F1 include the aforementioned dimension 100L3 (the dimension 100L3 is not illustrated in FIG. 10A). Taking the driving joint 2D_5 as an example, the joint dimension of its joint information F1 includes the dimension 100L4 (the dimension 100L4 is illustrated in FIG. 10A). Taking the driving joint 2D_6 as an example, the joint dimension of its joint information F1 includes the dimension 100L5 (the dimension 100L5 is illustrated in FIG. 10A).

As illustrated in FIGS. 10B and 10B, when the robotic arm 2 is assembled, the controller 1C may obtain the assembly sequence and/or the assembly posture of these joints (for example, the pairing of two fixing elements of two joints) according to the joint identification code of the joint information F1 of each joint to obtain the configuration of the robotic arm 2. For another example, the controller 1C may obtain the characteristic dimensions L21, L22, L23 and L24 of the robotic arm 2 according to the joint dimensions (100L1, 100L2, 100L3, 100L4 and/or 100L5) of the joint information F1 of each joint. The characteristic dimension L21 is, for example, the distance between the central axis 120S of the driving joint 2D_1 and the central axis 130S of the driving joint 1D_2, the characteristic dimension L22 is, for example, the distance between the central axis 120S of the driving joint 2D_2 and the central axis 120S of the driving joint 2D_3, the characteristic dimension L23 is, for example, the distance between the central axis 120S of the driving joint 2D_3 and the rotation axis (i.e., Z₄-axis) of the driving joint 2D_5, and the characteristic dimension L24 is, for example, the distance between the central axis 120S of the driving joint 2D_4 and the central axis 130S of the driving joint 2D_3. The controller 1C may adopt appropriate kinematic analysis technology to perform kinematic analysis on the robotic arm 2 according to these characteristic dimensions L21, L22, L23 and L24 to obtain position the analysis result, the velocity analysis result and/or the acceleration analysis result of the robotic arm 2.

As illustrated in FIG. 10B, the number of degrees of freedom of the robotic arm 2 is determined by the number of the driving joints. For example, if the number of the driving joints 2D_1, 2D_2, 2D_3, 2D_4, 2D_5 and 2D_6 is six, the robotic arm 3 is a six-axis robotic arm. The robotic arm 2 in FIG. 10B is upright-type when in use, so the robotic arm 2 may be defined as a six-axis vertical robotic arm. As illustrated in FIG. 10C, the robotic arm equivalent model 2′ includes the blocks B21 to B26 which respectively represent the driving joints 2D_1, 2D_2, 2D_3, 2D_4, 2D_5 and 2D_6. Z₀ represents the rotational freedom of the driving joint 2D_1 relative to the base 1B, Z₁ represents the rotational freedom of the driving joint 2D_2 relative to the driving joint 2D_1, Z₂ represents the rotational freedom of the driving joint 2D_4 relative to the driving joint 2D_3, Z₃ represents the rotational freedom of the connecting-rod joint 2L_2 relative to the driving joint 2D_4, Z₄ represents the rotational freedom of the driving joint 2D_6 relative to the connecting-rod joint 2L_2, and Z₅ represents the rotational freedom of another docking element (not shown, such as a flange or another joint) relative to the driving joint 2D_6, wherein the other docking element is connected to the driving joint 2D_6.

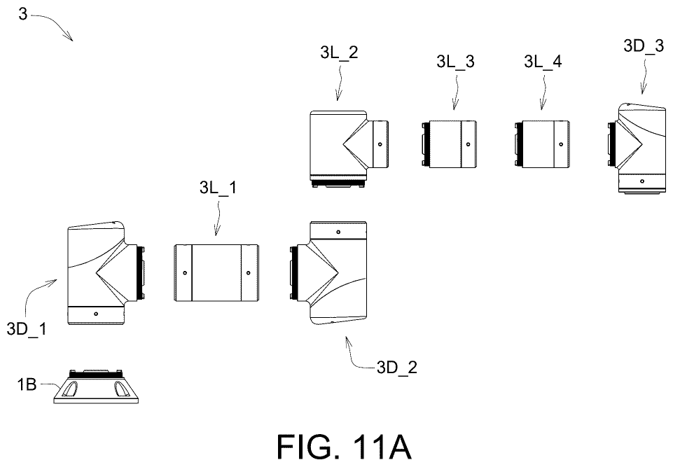

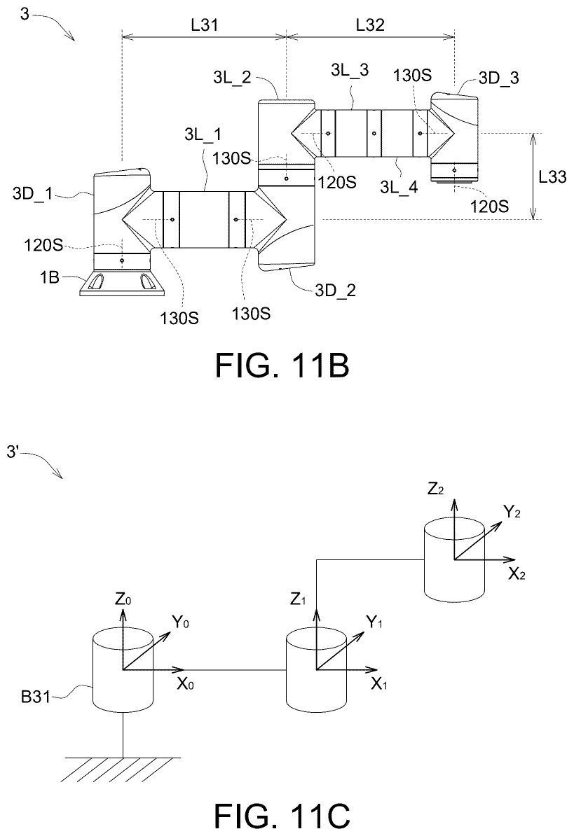

Referring to FIGS. 11A to 11C, FIG. 11A shows a schematic diagram of an exploded view of a robotic arm 3 according to another embodiment of the present disclosure, FIG. 11B shows a schematic diagram of an assembled view of the robotic arm 3 in FIG. 11A, and FIG. 11C shows a schematic diagram of a robotic arm equivalent model 3′ of the robotic arm 3 in FIG. 11B.

As illustrated in FIGS. 11A and 11B, the robotic arm 3 includes the base 1B, a driving joint 3D_1, a driving joint 3D_2, a driving joint 3D_3, a connecting-rod joint 3L_1, a connecting-rod joint 3L_2, a connecting-rod joint 3L_3, a connecting-rod joint 3L_4 and the controller 1C. The driving joints 3D_1, 3D_2 and 3D_3 each includes the structure of the joint 100 or itself is the joint 100, and the connecting-rod joints 3L_1, 3L_2, 3L_3 and 3L_4 each includes the structures the same as or similar to that of the connecting-rod joint 1L_1.

As illustrated in FIG. 11B, two of the joints in FIG. 11A may be connected together using the manner as described above. For example, the driving joint 3D_1 is connected to the base 1B, the connecting-rod joint 3L_1 is connected to the driving joint 3D_1, the driving joint 3D_2 is connected to the connecting-rod joint 3L_1, the connecting-rod joint 3L_2 is connected to the driving joint 3D_2, the connecting-rod joint 3L_3 is connected to the connecting-rod joint 3L_2, the connecting-rod joint 3L_4 is connected to the connecting-rod joint 3L_3, and the driving joint 3D_3 is connected to the connecting-rod joint 3L_4.

As illustrated in FIG. 11B, the controller 1C is electrically connected to the robotic arm 3. Each joint may communicate with the controller 1C via the EtherCAT communication protocol. Each joint records the joint information F1. When the joint is electrically connected to the controller 1C, the joint may transmit joint information F1 to the controller 1C. The controller 1C is configured to obtain the configuration of the robotic arm 3 of these joints according to the joint information F1 sent back by each joint, as illustrated in FIG. 11B; and perform a robotic analysis on the configuration of the robotic arm 1, such as kinematic analysis and/or kinematic analysis. The kinematic analysis and/or kinematic analysis performed by the controller 1C on the robotic arm 3 is similar to the kinematic analysis and/or kinematic analysis performed on the robotic arm 1 as stated above, and they will not be repeated here.

The joint information F1 includes the joint identification code, the joint dimension (or size) and/or the driver specification, wherein the joint identification code is, for example, the identification information of the joint. Different joints have different joint identification codes, and the driver specification includes the driver weight, the driver torque and/or the driver speed. Taking the joint 100 illustrated in FIG. 6 as an example, the joint dimensions of the joint information F1 of the joint 100 include dimensions 100L1 and 100L2; similarly, the joint dimensions of the joint information F1 of each of the driving joints 3D_1 to 3D_3 in FIG. 11A include the dimensions 100L1 and 100L2 (the dimensions 100L1 and 100L2 are not illustrated in FIG. 11A). For example, the joint dimensions of the connecting-rod joints 3L_1 to 3L3 include the aforementioned dimension 100L3 (the dimension 100L3 is not illustrated in FIG. 11A).

As illustrated in FIG. 11B, when the robotic arm 3 is assembled, the controller 1C may obtain the assembly sequence and/or the assembly posture of these joints (for example, the pairing of two fixing elements of two joints) according to the joint identification code of the joint information F1 of each joint to obtain the configuration of the robotic arm 3. For another example, the controller 1C may obtain the characteristic dimensions L31, L32 and L33 of the robotic arm 3 according to the joint dimensions (100L1, 100L2 and/or 100L3) of the joint information F1 of each joint. The characteristic dimension L31 is, for example, the distance between the central axis 120S of the driving joint 3D_1 and the central axis 130S of the connecting-rod joint 3L_1, the characteristic dimension L32 is, for example, the distance between the central axis 130S of the connecting-rod joint 3L_1 and the central axis 120S of the driving joint 3D_3, and the characteristic dimension L33 is, for example, the distance between the central axis 130S of the driving joint 3D_3 and the central axis 130S of the driving joint 3D_2. The controller 1C may perform kinematic analysis on the robotic arm 3, by using the appropriate kinematic analysis technology, according to these characteristic dimensions L31, L32 and L33, so as to obtain the position analysis result, the velocity analysis result and/or the acceleration analysis result of the robotic arm 3.

As illustrated in FIG. 11B, the number of degrees of freedom of the robotic arm 3 is determined by the number of the driving joints. For example, the number of the driving joints 3D_1, 3D_2 and 3D_3 is three, and the robotic arm 3 is a three-axis robotic arm. The robotic arm 3 in FIG. 11B is horizontal when in use, so the robotic arm 3 may be defined as a three-axis horizontal robotic arm. As illustrated in FIG. 11C, the robotic arm equivalent model 3′ includes the blocks B31 to B33 which respectively represent driving joints 3D_1, 3D_2, and 3D_3. Z₀ represents the rotational freedom of the driving joint 3D_1 relative to the base 1B, Z₁ represents the rotational freedom of the connecting-rod joint 3L_2 relative to the driving joint 3D_2, and Z₂ represents the rotational freedom of another docking element (not illustrated, such as a flange or another joint) relative to the driving joint 3D_3, wherein the another docking element is connected to the driving joint 3D_3.

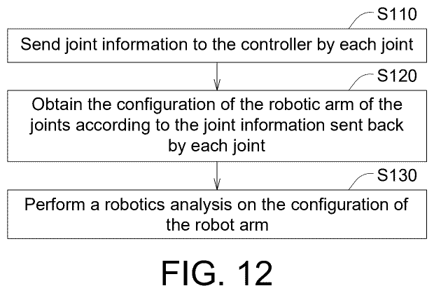

Referring to FIG. 12, FIG. 12 shows a flow chart of an analysis method for a robotic arm according to an embodiment of the present disclosure.

In step S110, when a plurality of the joints are electrically connected to the controller 1C, each joint transmits the joint information F1 to the controller 1C. The aforementioned joints are, for example, the joints of any of the aforementioned embodiments, and these joints constitute the robotic arm.

In step S120, the controller 1C obtains the configuration of the robotic arm constituted by these joints according to the joint information F1 sent back by each joint. Different joint types have different joint information F1. The joint information F1 includes, for example, the joint identification code, the joint dimension and/or the driver specification which have been stated above, and they will not be repeated here.

In step S130, the controller 1C performs the robotics analysis on the configuration of the robotic arm, such as the kinematics analysis and/or the kinematical analysis.

In summary, the embodiments of the present disclosure provide a joint, a robotic arm using the same and an analysis method using the same. The joint may be a driving joint or a connecting-rod joint. The driving joint includes a joint housing, at least one first fixing element, at least one second fixing element, a driver, at least one limiting element, at least one first circuit module and at least one second circuit module, wherein the first fixing element, the limiting element and the first circuit module may be located at a first connection end of the joint, and the second fixing element and the second circuit module are located at a second connection end of the joint, wherein the first connection end and the second connection end are respectively opposite ends (or opposite sides) or adjacent ends (or adjacent sides) of the joint housing. In an embodiment, the first connection end is, for example, a female end, and the second connection end is, for example, a male end. The joint housing may be in a straight-line shape, an L shape, a T shape or other suitable shape. The connecting-rod joint includes the same or similar elements as the driver joint, except that the connecting-rod joint may omit the drive. Due to the modular design of the joints, it may support flexible manufacturing capabilities of small quantities and a variety of products. In an embodiment, a plurality of the joints are connected to form a robotic arm, and the robotic arm includes at least one driving joint and/or at least one connecting-rod joint (optional), wherein a controller may perform robotic analysis on the robotic arm according to joint information of each joint. In addition, through the modular design of the joints, multiple joints may be assembled into a multi-axis (or multi-degree-of-freedom) robotic arm, such as a robotic arm with more than two axes, and/or multiple joints may be assembled into a robotic arm with a preset posture (for example, upright, horizontal or other geometric configurations).

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A joint, comprising;
a joint housing;
a first fixing element, rotatably connected to the joint housing and comprising a first fixing portion and a limiting protrusion;
a second fixing element, fixed to the joint housing and having a second surface, a second abutting surface and a second fixing portion, wherein the second abutting surface extends inwardly relative to the second surface; and
a limiting element, having a first surface, a first abutting surface and a limiting recess, wherein the first abutting surface extends outwardly relative to the first surface;
wherein the limiting protrusion is located in the limiting recess, and the first fixing portion and the second fixing portion respectively have structures that are matched.

2. The joint as claimed in claim 1, wherein the first fixing portion is a female thread, and the second fixing portion is a male thread.

3. The joint as claimed in claim 1, further comprising:
a driver, connected to the limiting element;
wherein when the first fixing element of the joint is connected to the second fixing element of another joint, relative positions among the limiting element, the first fixing element of the joint and the second fixing element of the another joint are fixed.

4. The joint as claimed in claim 1, wherein a dimension of the limiting recess along a direction is greater than a dimension of the limiting protrusion along the direction.

5. The joint as claimed in claim 1, wherein a slope of the first abutting surface is the same as a slope of the second abutting surface.

6. A robotic arm, comprising:
a plurality of joints, wherein two of the joints are connected to each other, and each of the joints records a joint information; and
a controller, electrically connected to the joints and configured to:
obtain a configuration of a robotic arm of the joints according to the joint information sent back by each joint; and
perform a robotics analysis on the configuration of the robotic arm;
wherein each of the joints comprises:
a joint housing;
a first fixing element, rotatably connected to the joint housing and comprising a first fixing portion and a limiting protrusion;
a second fixing element, fixed to the joint housing and having a second surface, a second abutting surface and a second fixing portion,
wherein the second abutting surface extends inwardly relative to the second surface;
a limiting element, having a first surface, a first abutting surface and a limiting recess, wherein the first abutting surface extends outwardly relative to the first surface;
wherein the limiting protrusion is located in the limiting recess, the first fixing portion and the second fixing portion respectively have structures that are matched, and the first fixing element of one of the joints is connected to the second fixing element of another of the joints.

7. The robotic arm as claimed in claim 6, wherein the joint information comprises a joint identification code, a joint dimension and/or a driver specification.

8. The robotic arm as claimed in claim 6, wherein the first fixing portion is a female thread, and the second fixing portion is a male thread.

9. The robotic arm as claimed in claim 6, wherein one of the joints further comprises:
a driver, connected to the limiting element;
wherein when the first fixing portion of the joint is connected to the second fixing portion of the another of the joints, relative positions among the limiting element, the first fixing portion of the joint and the second fixing portion of the another joint are fixed.

10. The robotic arm as claimed in claim 6, wherein a dimension of the limiting recess along a direction is greater than a dimension of the limiting protrusion along the direction.

11. The robotic arm as claimed in claim 6, wherein a slope of the first abutting surface is the same as a slope of the second abutting surface.

12. An analytical method for a robotic arm, comprising:
transmitting, by each of the joints, a joint information to a controller when a plurality of joints are electrically connected to the controller;
obtaining, by the controller, a configuration of a robotic arm constituted by the joints according to the joint information sent back by each of the joints; and
performing a robotics analysis on the configuration of the robotic arm.

13. The analytical method as claimed in claim 12, wherein the joint information comprises a joint identification code, a joint dimension and/or a driver specification.
